(19) United States
(12) Patent Application Publication
(10) Pub. No.: US 2006/0170329 A1
(43) Pub. Date: Aug. 3, 2006

(54) Image display device

(76) Inventors: Toshio Tojo, Chosei (JP); Nobuyasu Hayashi, Chosei (JP); Katsuyuu Takahashi, Chosei (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/333,202

(22) Filed: Jan. 18, 2006

(30) Foreign Application Priority Data
Jan. 18, 2005 (JP) 2005-010414

(51) Int. Cl. H01J 63/04

(52) U.S. Cl. 313/495

(57) ABSTRACT

An image display device includes: a front substrate having phosphor layers and a light reflective film succeeding the phosphor layers and composed chiefly of aluminum on an inner surface thereof; a rear substrate having plural electron sources on an inner surface thereof, and disposed to oppose the front substrate with a specified spacing between the front and rear substrates; and a support member which is sandwiched between the front and rear substrates, surrounds a display area formed between the front and rear substrates, and maintains the specified spacing. Two end faces of the support member are hermetically sealed to the front substrate and the rear substrate, respectively, via sealing members. A thickness of the light reflective film is in a range of from 50 nm to 200 nm, and an average film density of the light reflective film is in a range of from 1.6 g/cm³ to 2.6 g/cm³.

### CLAIM OF PRIORITY

The present application claims priority from Japanese application serial No. 2005-010414, filed on Jan. 18, 2005, the content of which is hereby incorporated by reference into this application.

### BACKGROUND OF THE INVENTION

The present invention relates to a flat panel type image display device which utilizes emission of electrons into a vacuum produced between a front substrate and a rear substrate, and in particular to an image display device provided with a light-reflective film disposed to cover phosphors on the front substrate.

Conventionally, color cathode ray tubes have been widely used as display devices excellent in producing high-brightness high-definition display devices. However, as the image quality in information processing equipment and TV broadcasts has been improved in recent years, the demand has been becoming stronger for flat panel type display devices (hereinafter FPD) capable of realizing lighter weight and space-saving in addition to the performance of high brightness and high definition. As their typical examples, liquid crystal display devices and plasma display devices have been put to practical use.

Further, various types of flat panel type display devices are under development for practical use. Especially as display devices capable of realizing higher brightness, light-emission type image display devices are being developed which utilize emission of electrons into a vacuum from electron sources. For example, they are ones called electron-emission type image display devices, field emission type image display devices. Organic electroluminescent (EL) display devices are also being developed which feature low power consumption.

Among the light-emission type display devices of such flat panel type image display devices, known is one employing a plurality of electron sources arranged in a matrix fashion. By way of an example, one of the above-mentioned electron-emission type image display device is known which employs very small cold cathodes capable of being packed at a high density.

The light-emission type flat panel displays use cold cathodes of the Spindt type, the surface conduction type, the carbon nanotube type, the MIM (Metal-Insulator-Metal) type employing stacked metal, insulator and metal layers, the MIS (Metal-Insulator-Semiconductor) type employing stacked metal, insulator and semiconductor layers, or the thin film type electron sources comprised of metal, insulator, semiconductor and metal films.

Some electron sources of the MIM type are disclosed by Japanese Patent Application Laid-Open publications Nos. Hei 7-65710 and 10-153979, for example. A MOS type electron source of the MIS type is reported by J. Vac. Sci. Technol. B11 (2), pp. 429-432(1993). A HEED type electron source of the metal-insulator-semiconductor-metal type is reported by “High-efficiency-electron-emission device,” Jpn. J. Appl. Phys., Vol. 136, pL 939. An electron source of the EL type is reported by an article “Electroluminescence,” Japanese specialist magazine “Applied Physics, ” Vol. 63, No. 6,p 592.A porous silicon type electro source is reported by Japanese specialist magazine “Applied Physics,” Vol. 66, No. 5, p 437.

As an example of the electron emission type FPD, a display panel is known which comprises: a rear substrate provided with electron sources such as those explained above; a front substrate disposed to face the rear substrate and provided with phosphor layers and anodes supplied with accelerating voltages for striking the phosphor layers with electrons emitted from the electron sources; and a support member which serves as a sealing peripheral frame for sealing together the front and rear substrates to obtain a required degree of vacuum in the space between the front and rear substrates. This display panel is operated by using a driver circuit.

In an image display device employing electron sources of the MIM type, its rear substrate is comprised of a substrate made of an insulating material. Formed on the insulating substrate are a plurality of scanning signal lines which extend in a first direction, are arranged in a second direction perpendicular to the first direction, and are supplied with scanning signals successively in the second direction. Also formed. on the insulating substrate are a plurality of video signal lines which extend in the second direction and are arranged in the first direction so as to intersect the scanning signal lines. Each of the intersections of the scanning signal lines and the video signal lines is provided with a corresponding one of the electron sources which is coupled to a corresponding one of the scanning signal lines with a connector electrode for supplying an electric current to the corresponding one of the electron sources.

Each of the electron sources forms a unit pixel in combination with a corresponding one of phosphor layers. Usually three unit pixels of three colors, red (R), green (G) and blue (B), respectively, forms one pixel (also referred to as a color pixel). When the technical term “color pixel” is utilized, a unit pixel may be referred to as a subpixel.

As described above, in the flat panel type image display device, generally a plurality of spacing-maintaining members (hereinafter spacers) are arranged and fixed in a display area surrounded by a support member between the front and rear substrates so as to maintain the spacing between the front and rear substrates at a desired value in cooperation with the support member. The spacers are generally plate-like members made of insulating material such as glass and ceramics, and generally each of the spacers is disposed for every plural pixels in a position which does not interfere with operation of the pixels.

Japanese Patent Application Laid-Open No. 2002-124199 publication proposes a flat panel type image display device in which its anode panel is provided with a partition in the form of a grid pattern, for example, on its interior surface facing its cathode panel, phosphors are disposed within respective squares of the grid pattern, and a reflective film is supported by the partition such as to cover the phosphors and the partition and also to serve as an anode.

### SUMMARY OF THE INVENTION

An anode voltage of FPD of the electron emission type is generally selected to be in a range of from several kilovolts to some dozen kilovolts, and therefore the anode voltage of the FPD of the electron emission type is lower than 25-30 kV required for driving of cathode ray tubes. Electron beams emitted from the electro sources lose their energy due to the presence of an electro-conductive light-reflective film (hereinafter a metal back or a metal back film) which covers phosphor layers and serves as the anode, and consequently, brightness of the image display device is greatly degraded. Therefore it is indispensable to make the metal back film thinner for eliminating this problem.

However, reducing of the thickness of the metal back film produces side effects of reductions in electrical conductivity and light reflectance, and it is necessary to select the thickness and density of the metal back film so as to strike a balance among the reductions in display brightness, electrical conductivity and light reflectance.

In the case of cathode ray tubes, the metal back film can be considered as located in a space where no electric fields are present, but in the case of the FPD of the electron emission type, since the spacing between the front and rear substrates are selected in a range of from several millimeters to several tens of millimeters, the metal back film are located under strong electric fields of 2 kV/mm to 3 kV/mm, are always subjected to strong coulomb forces during operation of the FPD of the electron emission type, and there is a fear of peeling of the metal back film. Consequently, it is essential to increase of the strength of the metal back film, and to increase the adherence of the metal back film to the underlying layer.

Further, the metal back film needs to be formed with pinholes therein for passing therethrough gases emitted from the underlying layer during the treatment of firing the underlying layer. On the other hand, formation of the dense and continuous metal back film is required for the purpose of increasing display brightness, electrical conductivity, and light reflectance of the metal back film, and increasing the strength of the metal back film and adherence of the metal back film to the underlying layer. However, there are problems in that in the case of the dense and continuous metal back film it is difficult to form pinholes therein and the film itself swells and breaks easily, and this problems need to be solved.

As a solution to the above problems, the above-cited Japanese Patent Application Laid-Open No. 2002-124199 publication discloses a configuration in which a flat light reflective film made of aluminum or chromium is formed to a thickness in a range of from 30 nm to 150 nm, and in which secondary electrons emitted from phosphor layers are reflected back to the phosphor layers or are absorbed by the film. However, the following problems (a) to (c) are not solved even by the invention disclosed in the above-cited Japanese Patent Application Laid-Open No. 2002-124199 publication, and further measures for solving the problems are demanded.

(a) While only the thickness of the metal back film is specified, the density of the film is also an important controlling factor for electron transmission and light reflectance as well as the thickness of the film. It is difficult to obtain the desired characteristics of the metal back film by specifying the film thickness only.

(b) When the thickness of the metal back film is equal to or smaller than 50 nm, the metal back film cannot avoid the reductions in light reflectance and electrical conductivity due to oxidation even if the density of the film is selected to be equal to the density of the bulk state.

(c) The metal back film made of aluminum is adhered to the phosphor layers in a point-contact fashion. If the aluminum metal back film is made flatter, the number of the contacts is decreased, and consequently, peeling of the aluminum film occurs easily due to insufficient adherence of the aluminum film to the phosphor layers under the strong electric fields as in the case of FPD of the electron emission type.

The above problems can be solved by specifying the film thickness and film density of the light reflective film, and the surface roughness of the light reflective film. The following will explain the summary of the representative ones of the inventions disclosed in this specification.

(1) An image display device comprising: a front substrate having phosphor layers and a light reflective film succeeding said phosphor layers and comprised chiefly of aluminum on an inner surface thereof; a rear substrate having a plurality of electron sources on an inner surface thereof, and disposed to oppose said front substrate with a specified spacing between said front and rear substrates; and a support member which is sandwiched between said front and rear substrates, surrounds a display area formed between said front and rear substrates, and maintains said specified spacing; two end faces of said support member being hermetically sealed to said front substrate and said rear substrate, respectively, via sealing members, wherein a thickness of said light reflective film is in a range of from 50 nm to 200nm, and an average film density of said light reflective film is in a range of from 1.6 g/cm³ to 2.6 g/cm³.

(2) An image display device according to (1), wherein said rear substrate is provided with: a plurality of scanning signal lines extending in one direction and arranged in another direction intersecting said one direction, said plurality of scanning signal lines being adapted to be supplied with a scanning signal successively in said another direction; a plurality of video signal lines extending in said another direction and arranged in said one direction to intersect said plurality of scanning signal lines; a plurality of electron sources each disposed in a vicinity of a corresponding one of intersections of said plurality of scanning signal lines and said plurality of video signal lines; and a plurality of connector electrodes which couples each of said plurality of electron sources to a corresponding one of said plurality of scanning signal lines.

(3) An image display device according to (1), wherein said average film density of said light reflective film is in a range of from 1.8 g/cm³ to 2.4 g/cm³.

(4) An image display device according to (1), wherein said light reflective film is comprised chiefly of aluminum, and contains at least one of neodymium, manganese and silicon.

(5) An image display device according to (1), wherein said light reflective film is provided with a passive-state film on an outer surface thereof.

(6) An image display device according to (1), wherein a mass per unit area of said aluminum in said light reflective film is in a range of from 10 μg/cm² to 50 μg/cm² in said display area.

(7) An image display device according to (1), wherein said light reflective film is provided with pinholes therein.

(8) An image display device according to (1), wherein said light reflective film is provided with pinholes therein, and a diameter of said pinholes is equal to or smaller than 5 μm.

(9) An image display device according to (1), wherein said light reflective film is provided with pinholes therein, and a diameter of said pinholes is in a range of from 1 μm to 2 μm.

(10) An image display device according to (1), wherein a total luminous reflectance of said light reflective film is equal to or greater than 60%.

(11) An image display device according to (1), wherein a difference between a maximum and a minimum of spectral reflectance of said light reflective film is equal to or smaller than 10% inavisible region of from 400 nm to 700 nm in wave length.

(12) An image display device according to (1), wherein said light reflective film is provided with roughness equal to greater than a thickness of said light reflective film.

(13) An image display device according to (1), wherein Rz (ten points average height, peak to valley average) of said light reflective film is in a range of from 3 μm to 15 μm.

(14) An image display device according to (5), wherein said passive-state film of said light reflective film is provided with at least one of barium, magnesium, iron, nickel and titanium on a surface of said passive-state film.

(15) An image display device comprising: a front substrate having a black matrix film having a plurality of openings therein and disposed on an inner surface of said front substrate, phosphor layers filling and extending outside of said plurality of openings, and a light reflective film covering said phosphor layers and said black matrix film and comprised chiefly of aluminum; a rear substrate having a plurality of electron sources on an inner surface thereof, and disposed to oppose said front substrate with a specified spacing between said front and rear substrates; a plurality of spacing-maintaining members which are sandwiched between said front and rear substrates in a display area formed between said front and rear substrates; and a support member which is sandwiched between said front and rear substrates, surrounds said display area, and maintains said specified spacing; two end faces of said support member being hermetically sealed to said front substrate and said rear substrate, respectively, via sealing members, wherein a thickness of said light reflective film is in a range of from 50 nm to 200 nm, an average film density of said light reflective film is in a range of from 1.6 g/cm³ to 2.6 g/cm³, and said light reflective film is provided with a passive-state film on an outer surface thereof.

(16) An image display device according to (1), wherein said light reflective film is adapted to be supplied with an anode voltage in a range of from 5 kV to 15 kV.

As the thickness of the metal back film is made smaller, the electron transmission therethrough becomes higher, and display brightness increases. On the other hand, when the light reflectance (the efficiency of utilization of light generated by phosphors) is considered, it is advantageous to increase the thickness of the metal back film to a certain value. The invention recited in (1) is capable of providing an image display device provided with a high-brightness, highly-reliable phosphor screen by specifying the film thickness and film density of the aluminum film so as to optimize the electron transmission and light reflectance.

By employing thin-film electron sources, for example, the invention recited in (2) is capable of providing an image display device which features a superior electron beam focusing, superior electron emission characteristics, long life and high reliability obtained by solving a problem of surface contamination of the electron sources, and a high-definition display.

The invention recited in (3) is capable of providing an image display device provided with a high-brightness, highly-reliable phosphor screen by specifying the film thickness and film density of the aluminum film further to optimize the electron transmission and light reflectance of the aluminum film.

Since aluminum is low in density, does not cause much energy loss, and is superior in light reflectance, desired light reflectance, electron transmission and electrical conductivity can be obtained. The high display brightness and high electrical conductivity can be established by adjusting the film thickness and film density, and high reliability can be achieved by formation of pinholes and unevenness in the aluminum film. Addition of neodymium to the aluminum film is capable of reducing occurrence of hillocks, and thereby produces the flat aluminum film advantageous for light reflectance. Addition of manganese or silicon reduces occlusion of discharge gases, thereby reducing outgassing by bombardment of electrons during operation of the panel, and provides a long-life highly reliable image display device.

The invention recited in (5) reduces oxidation is capable of protecting the metal aluminum layer by reducing oxidation of aluminum in the metal back film during the heat treatment for burning off and thermally decomposing the underlying organic resin materials after formation of the metal back film, during the step of fixing to the rear substrate, and during the heat treatment in the evacuation step. The passive-state film prevents negative ions produced by bombardment of electron beams on residual gas molecules within the panel, from striking directly the metal aluminum layer, and thereby achieves stabilization of characteristics such as light reflectance and electrical conductivity of the metal back film.

In the invention recited in (6), the metal back film is comprised chiefly of aluminum, and the mass of the aluminum is specified to obtain the desired light reflectance, electron transmission and electrical conductivity.

The inventions recited in (7) to (9) are capable of preventing swelling and peeling of the metal back film, and providing the desired light reflectance, electron transmission and electrical conductivity.

The invention recited in (10) is capable of producing high brightness in all of three color (R, G, B) regions.

By specifying the total luminous reflectance of the aluminum thin film in the visible region, the invention recited in (11) is capable of producing high brightness in all of three color (R, G, B) regions, and is capable of improving white brightness by making very small the differences in light reflectance of the aluminum over the visible regions.

The inventions recited in (12) and (13) improves adhesion of the metal back film to the phosphor layers by increasing the number of contacts of the phosphor layers and the metal back film.

The invention recited in (14) is capable of maintaining the panel at a high degree of vacuum and achieving long life by adsorbing the residual gas molecules within the panel.

The invention recited in (15) is capable of improving the display brightness and the light reflectance of the metal back film, and provides an image display device provided with a highly reliable phosphor screen.

The invention recited in (16) provides a highly reliable image display device by suppressing occurrence of damage to the metal back film, and achieving the improvement in display brightness and light reflectance of the metal back film regardless of low-voltage driving.

### BRIEF DESCRIPTION OF THE DRAWINGS

In the accompanying drawings, in which like reference numerals designate similar components throughout the figures, and in which:

FIGS. 1(a) and 1(b) are illustrations for explaining an embodiment of the image display device in accordance with the present invention, FIG. 1(a) being a plan view of the image display device viewed from its front-substrate side, and FIG. 1(b) being a side view of the image display device of FIG. 1(a) viewed in a direction of an arrow A of FIG. 1(a);

FIG. 2 is a schematic plan view of a rear substrate of the image display device of FIG. 1(a) with its front substrate removed;

FIG. 3 is a schematic cross-sectional view of the rear substrate of FIG. 2 taken along line III-III of FIG. 2 and a corresponding portion of the front substrate taken along line III-III of FIG. 2;

FIG. 4 is a schematic plan view of a phosphor screen of the image display device of FIG. 1 viewed from its rear-substrate side;

FIG. 5 is a schematic cross-sectional view of the phosphor screen of FIG. 4 taken along line V-V in FIG. 4;

FIG. 6 is an enlarged schematic cross-sectional view of a portion of the phosphor screen of FIG. 4;

FIG. 7 is a schematic plan view of a phosphor screen of another embodiment of the image display device in accordance with the present invention;

FIG. 8 is a process chart for explaining an example of a method of fabricating an image display device in accordance with the present invention;

FIG. 9 is a graph showing a relationship between a relative surface area of a metal back film and the surface roughness Rz of phosphor layers after completion of a filming step;

FIG. 10 is a graph showing a relationship between electron transmission and a thickness of the metal back film for explaining the image display device in accordance with the present invention;

FIG. 11 is a graph showing a relationship between light reflectance and a thickness of the metal back film for explaining the image display device in accordance with the present invention;

FIG. 12 is a graph showing a relationship between display brightness and a thickness of the metal back film for explaining the image display device in accordance with the present invention; and

FIG. 13 is a graph showing a relationship between light reflectance and a film density of the metal back film for explaining the image display device in accordance with the present invention.

### DETAILED DESCRIPTION OF THE PREFERRED EMBODIMENTS

In the following the embodiments of the present invention will be explained in detail by reference to the drawings.

### Embodiment 1

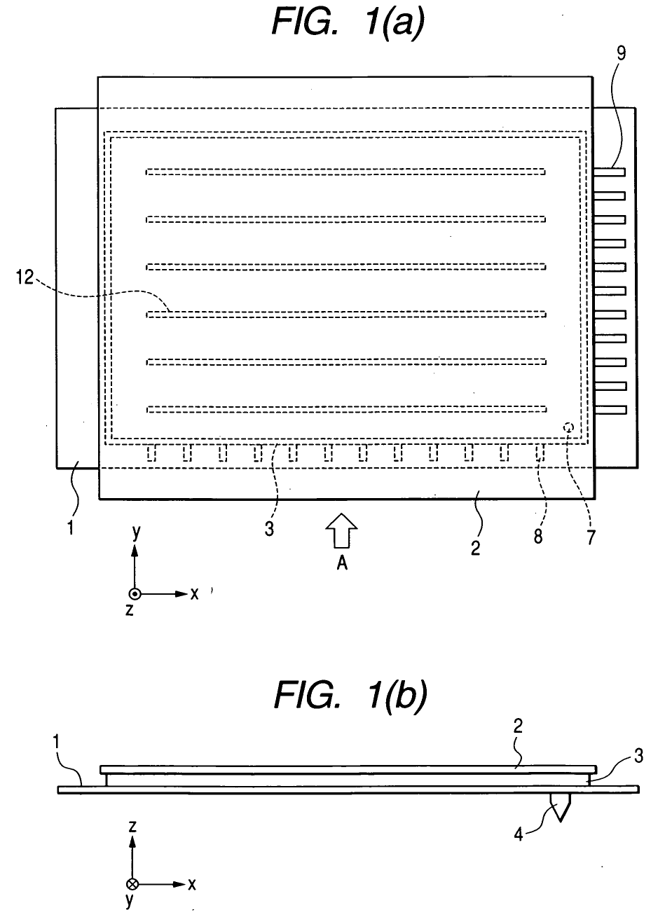

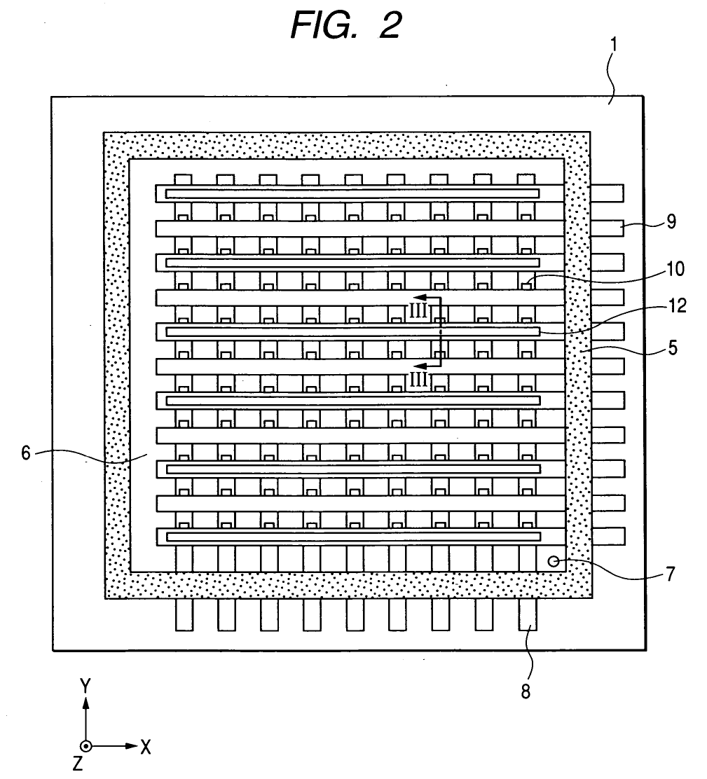

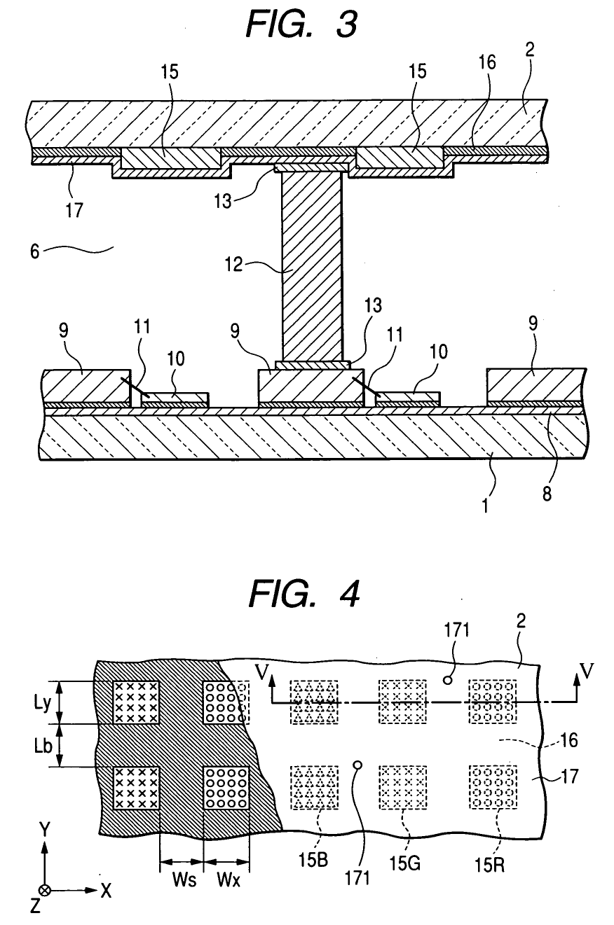

FIG. 1 (a) to FIG. 3 illustrate an embodiment of the image display device in accordance with the present invention. FIG. 1(a) is a plan view of the image display device viewed from its front-substrate side, FIG. 1(b) is a side view of the image display device viewed in a direction of an arrow A in FIG. 1(a), FIG. 2 is a schematic plan view of a rear substrate of the image display device of FIG. 1 with its front substrate removed, and FIG. 3 is a schematic cross-sectional view of the rear substrate of FIG. 2 taken along line III-III of FIG. 2 and a corresponding portion of the front substrate taken along line III-III. In FIGS. 1(a) to 3, reference numerals 1 and 2 denote the rear and front substrates, respectively, which are made of glass plates of several millimeters, for example about 3 mm, in thickness. Reference numeral 3 denotes a support member, which is made of a glass plate or a sintered glass frit of several millimeters, for example about 3 mm, in thickness. Reference numeral 4 denotes an exhaust tubulation, which is fixed to the rear substrate 1. The support member 3 is sandwiched between the rear and front substrates 1, 2 along their peripheries, and it is hermertically sealed to the rear and front substrates 1, 2 via a sealing member 5 (see FIG. 2) such as glass frit.

A space enclosed by the support member 3, the rear and front substrates 1, 2 and the sealing member 5 is evacuated via the exhaust tubulation 4, and is maintained at a vacuum in a range of from 10⁻³ to 10⁻⁵ Pa to provide a display area 6 (see FIG. 2).

The exhaust tubulation 4 is attached to an outer surface of the rear substrate 1 as described above and communicates with a through hole 7 pierced in the rear substrate 1, and the exhaust tubulation 4 is sealed off after completion of the evacuation.

Reference numeral 8 denotes video signal lines, which extend in a Y direction and are arranged in an X direction on an inner surface of the rear substrate 1 as shown in FIG. 2. Reference numeral 9 denotes scanning signal lines, which are disposed above the video signal lines 8, extend in the X direction intersecting the video signal lines 8 and are arranged in the Y direction. Reference numeral 10 denotes electron sources, each of which is disposed in the vicinity of a corresponding one of intersections of the scanning signal lines 9 and the video signal lines 8, and is connected to a corresponding one of the scanning signal lines 9 with a connector electrode 11. An interlayer insulating film is disposed between the video signal lines 8 and the scanning signal lines 9. The video signal lines 8 are comprised of an Al/Nd film, for example, and the scanning signal line 9 are comprised of an Ir/Pt/Au film, for example.

Reference numeral 12 denotes spacers. The spacers 12 are comprised of a ceramic material, and are shaped into rectangular thin plates. In this embodiment the spacers 12 are disposed to stand upright on every second one of the scanning signal lines 9. Usually the spacers 12 are disposed in positions of every plural pixels where the spacers 12 do not interfere with operation of pixels. The dimensions of the spacers 12 are determined based upon the dimensions of the rear and front substrates 1, 2, the height of the support member 3, the material of the rear and front substrates, the intervals of arrangement of the spacers 12, the material of the spacers 12 and others. Generally, from a practical point of view, the dimensions of the spacers 12 are selected as follows: the height is approximately equal to that of the support member 3, the thickness is in a range of from several tens of microns to several millimeters, the length is in a range of from 50 mm to 200 mm, preferably in a range of from 80 mm to 120 mm.

In FIG. 3, reference numeral 13 denotes adhesive members, which are formed of electro-conductive adhesive comprised of glass frit or glass components for an adhesive use, for example, mixed with silver, for example, and which bond and fix the spacers 12 to the rear and front substrates 1, 2. The thickness of the adhesive members 13 is selected to be some dozen microns or more, preferably 20 microns to 40 microns, for securing adhesion, although it depends upon the composition of the adhesive members 13.

Disposed on the inner surface of the front substrate 2 are the phosphor layers 15 partitioned into red phosphor portions, green phosphor portions and blue phosphor portions with a light-blocking black matrix (BM) film 16, and the metal back film (an anode electrode) 17 made of a metal thin film covering the phosphor layers 15 to complete a phosphor screen.

With this phosphor screen configuration, electrons emitted from the electron sources 10 are accelerated to impinge upon a portion of the phosphor layers 15 constituting an intended pixel, thereby the portion of the phosphor layers 15 generates light of a desired color, which is combined with the emission color of phosphors of other pixels to form a color pixel of a desired color. Although the anode electrode 17 is illustrated as unstructured, the anode electrode 17 may be made in the form of stripes intersecting the scanning signal lines 9, each of which stripes corresponds to one of columns of pixels.

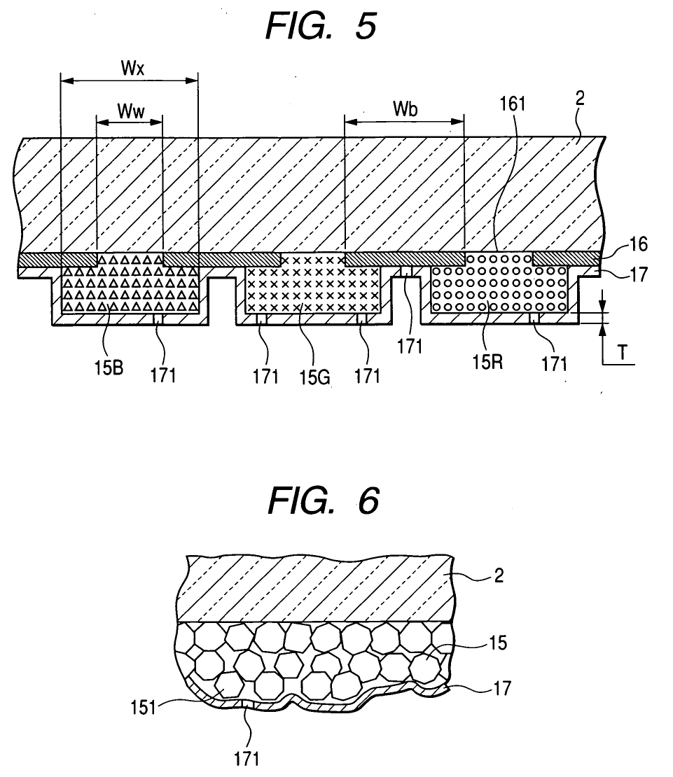

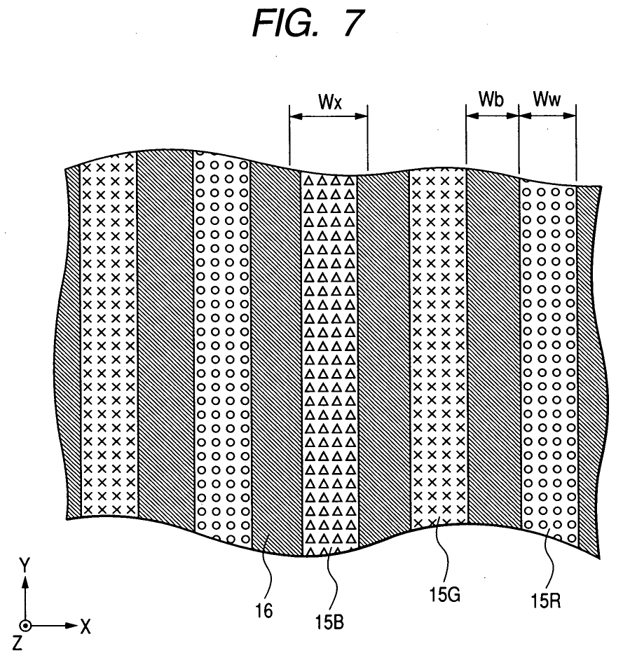

FIGS. 4 to 6 are illustrations for explaining the configuration of a phosphor screen on the front substrate 2 of an embodiment of the image display device shown in FIGS. 1(a) and 1(b) in accordance with the present invention. FIG. 4 is a schematic plan view of the phosphor screen viewed from its rear-substrate side, FIG. 5 is a schematic cross-sectional view of the phosphor screen of FIG. 4 taken along line V-V in FIG. 4, and FIG. 6 is an enlarged schematic cross-sectional view of the phosphor screen. In FIGS. 4 to 6, the BM film 16 is formed in an area of the front substrate 2 corresponding to the display area 6. The BM film 16 is provided with a plurality of openings (windows) 161. Green phosphor layers 15G, blue phosphor layers 15B and red phosphor layers 15R are deposited to fill respective ones of the openings 161. As examples for phosphors, Y₂O₂S:Eu (JEDEC phosphor type P22-R) may be used for red, ZnS:Cu, Al (JEDEC phosphor type P22-G) may be used for green, and ZnS:Ag, Cl (JEDEC phosphor type P22-B) may be used for blue.

In this configuration, in the rear view shown in FIG. 4, Wx denotes the overall width of each of the phosphor layers 15 measured in the X direction, and Ly denotes the overall length of each of the phosphor layers 15 measured in the Y direction, and in the front view of the phosphor layers 15, Ww denotes the width of each of the phosphor layers 15 measured in the X direction (see FIG. 5), and the width Ww is equal to the width Ww of the opening 161 in the BM film 16 measured in the X direction. The length in the front view of each of the phosphor layers 15 measured in the Y direction is selected to be equal to the width Ww. Wb denotes the width of the BM film 16 measured in the X direction, and Ws and Lb denote distances between adjacent ones of the phosphor layers 15 measured in the X and Y directions, respectively.

In this embodiment, each of the phosphor layers 15 extends outwardly from the approximate center of a corresponding one of the openings 161 in the BM film 16 onto the BM film 16. Although the relationship Wx>Ww is satisfied, the phosphor layers 15 are separated from each other in both the X and Y directions by the BM film 16, and therefore the phosphor layers 15 are arranged to form an array of plural dots. The dimensions of the phosphor layers 15 may be made different among the three colors.

The metal back film 17 comprised chiefly of aluminum is formed to cover the BM film 16 and the phosphor layers 15 by evaporation for example. The metal back film 17 is provided with a plurality of pinholes 171 piercing therethrough, and the pinholes 171 are utilized to passing therethrough gases emitted from the underlying organic planarizing film (filming film) and phosphor layers during the firing treatment.

By way of example, a configuration of the phosphor layers 15 and the metal back film 17 is shown in the enlarged schematic cross-sectional view of the phosphor screen of FIG. 6. Plural layers of the particulate phosphor particles 151 are stacked on each other, and therefore the phosphor layers 15 form an uneven surface on the front substrate 2. The metal back film 17 deposited on the phosphor layers 15 conforms to the uneven surfaces of the phosphor layers 15.

When electrons emitted from the electron sources 10 on the rear substrate 1 strike the phosphor layers 15 after passing through the metal back film 17, the phosphor particles 151 generate light, and images are formed on the phosphor screen of the above-explained configuration by light emitted forward from the front substrate 2.

It is important to improve the efficiency of utilization of the light for increasing the brightness of image display devices. One of functions of the metal back film is to serve as the light reflective film for increasing the efficiency of utilization of the light by reflecting back toward the front substrate 2 the light emitted toward the side opposite from the front substrate 2, that is, toward the rear substrate 1. Therefore the use of a highly-reflective metal thin film is desirable for the light reflective film 17, since the electron beams strike the phosphors 151 after passing through the light reflective film 17, it is necessary to minimize loss in energy of the electron beams caused by the light reflective film 17. In view of the above, since losses of energy caused by aluminum are not great because of its small density and light reflectance of aluminum is superior, aluminum is most suited for the material of the metal back film.

The metal back film 17 is comprised of an aluminum film provided with a passive-state film of aluminum oxide Al₂O₃ on its surface, and has the following configuration:

(1) Its thickness T is selected to be in a range of from 50 nm to 200 nm.

(2) Its average film density is selected to be in a range of from 1.6 g/cm³ to 2.6 g/cm³.

(3) The metal back film 17 has a plurality of pinholes 171 therein. The diameter of the pinholes 171 is about 5 microns or smaller, and is preferably in a range of from 1 micron to 2 microns. The configuration of the pinholes 171 is optimized so as to ensure sufficient light reflectance and its capability of functioning as outgassing holes for releasing gases produced by firing the underlying organic planarizing film (filming film) and the phosphor layers.

(4) The mass per unit area of the aluminum component of a portion of the metal back film 17 corresponding to each of the openings 161 in the BM film 16 is selected to be in a range of from 10 μg/cm² to 50 μg/cm². That is to say, the mass per unit area of the aluminum component of an image-forming area viewed from the front-substrate-2 side is selected to be in the above-mentioned range of from 10 μg/cm² to 50 μg/cm². The openings 161 are the areas corresponding to windows through which light emits into the outside of the front substrate 2. By specifying the mass of the portion of the metal back film 17 corresponding to each of the openings 161, the desired light reflectance, electron transmission and electrical conductivity are obtained. In a case where the metal back film 17 is formed by evaporation, for example, the metal back film 17 is sometimes formed over the entire area of the phosphor screen by evaporation at a time, and in this case the mass per unit area of the metal back film 17 is made equal to the above value over the entire area of the phosphor screen. However, it is sufficient that the mass of at least the image-forming portion of the metal back film 17 corresponding to each of the openings 161 is selected to be in the above-explained range.

(5) The total luminous reflectance of the metal back film 17 is selected to be 60% or more in the visible region of the spectrum. The phosphor layers are comprised of patterned red (R), green (G) and blue (B) phosphors, and brightness are increased in respective emission-color wavelengths. Here the total luminous reflectance is measured in accordance with JIS (Japanese Industrial Standard) K 7105-1981.

(6) The difference between the maximum and minimum of spectral reflectance of the metal back film 17 is 10% or smaller in the visible region of from 400 nm to 700 nm in wavelength. The red (R), green (G) and blue (B) phosphors of the phosphor layers are patterned, and white brightness is improved by reducing variations in light reflectance of the aluminum film 17 with emission-color wavelengths.

(7) The metal back film 17 has roughness equal to or greater than its thickness, and Rz (ten points average height, peak to valley average) is selected to be in a range of from 3 microns to 15 microns. Here the ten points average height, peak to valley, is measured in accordance with JIS (Japanese Industrial Standard) B 0601-1994. The adhesion of the metal back film 17 to the phosphor layers is improved by increasing the number of points of contact of the metal back film 17 with phosphor layers.

The configuration of Embodiment 1 makes it possible to increase the electron transmission, light reflectance, electrical conductivity, and adhesion of the metal back film and to prevent the metal back film from swelling, and consequently, the configuration of Embodiment 1 provides a high-brightness, long-life, and highly reliable image display device.

Further, in a case where the phosphor layers are patterned to form an array of dots, the damage to the phosphor layers is eliminated which may otherwise be caused by fixing spacers to the substrate, occurrence of peeling of the aluminum film is prevented, and therefore a high-brightness, long-life, and highly reliable image display device can be obtained.

### Embodiment 2

FIG. 7 shows another embodiment of the image display device in accordance with the present invention, and is a schematic plan view of a phosphor screen of the image display device viewed from the outside of the front substrate. The same reference numerals as utilized in the previous figures designate corresponding portions in FIG. 7.

In FIG. 7, a BM film 16 is formed in a portion corresponding to the display area 6 on the front substrate 2, and the BM film 16 is provided with plural openings (windows) 161 in the form of parallel lines. Green phosphor layers 15G, blue phosphor layers 15B and red phosphor layers 15R are deposited to fill corresponding ones of the openings 161. In this configuration, the phosphor layers 15 extend a distance of the width Wx across the width Ww of the opening 161 in the X direction, and extend a distance of the entire length of the display area 6 in the Y direction, and the BM film 16 extends a distance of the width Wb in the X direction and extends a distance of the entire length of the display area 6 in the Y direction. In this embodiment, each of the phosphor layers 15 extends outwardly from the approximate center of a corresponding one of the openings 161 in the BM film 16 onto the BM film 16. That is to say, the phosphor layers are arranged in the form of stripes satisfying the relationship Wx>Ww.

As in the case of the above-explained Embodiment 1, the metal back film 17 (not shown) comprised chiefly of aluminum is formed to cover the thus formed BM film 16 and phosphor layers 15 by evaporation, for example.

Further, it is needless to say that in Embodiment 2 also, the metal back film satisfies the requirements (1) to (7) explained in connection with Embodiment 1.

As in the case of Embodiment 1, the configuration of Embodiment 2 makes it possible to increase the electron transmission, light reflectance, electrical conductivity, and adhesion of the metal back film and to prevent the metal back film from swelling, and consequently, the configuration of Embodiment 2 provides a high-brightness, long-life, and highly reliable image display device.

Further, since the phosphor layers are patterned in the form of stripes, formation of the phosphor screen is facilitated, and consequently, the manufacturing yield rate is improved and further enlarging of the screen size can be realized.

### Embodiment 3

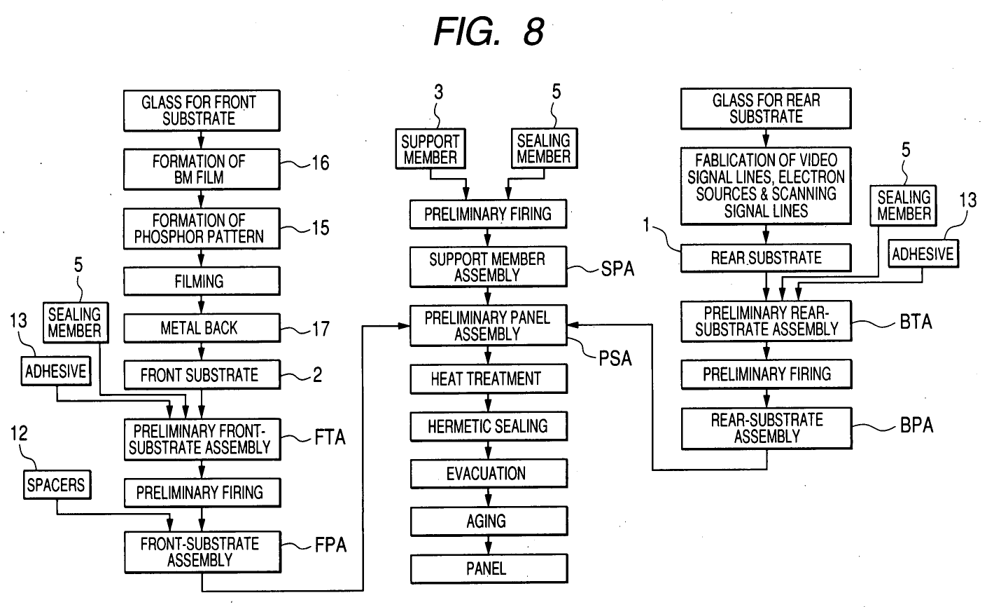

FIG. 8 is a process chart for explaining a method of fabricating an image display device in accordance with the present invention. The same reference numerals as utilized in FIG. 1(a) to FIG. 7 designate corresponding portions in FIG. 7.

In FIG. 8, the front substrate 2 includes on a glass substrate a phosphor screen comprised of the BM film 16, the phosphor pattern 15 and the metal back film (anode) 17. A preliminary front-substrate assembly FTA is obtained by coating a sealing member 5 comprised of noncrystalline glass frit kneaded with appropriate binder and adhesive members 13 for fixing spacers 7 and comprised of glass frit, for example, kneaded with appropriate binder, in the respective desired patterns on the front substrate 2 of the above configuration.

Here, instead of forming the sealing member 5 on the substrates, all of the sealing members may be formed on the support member 3.

After subjecting the preliminary front-substrate assembly FTA to a preliminary firing at a temperature high enough to drive off the binder, about 150 degrees centigrade, the adhesive members 13 and the spacers 12 are positioned at specified positions on the front substrate 2 by using jigs or the like (not shown), and then the front-substrate assembly FPA is formed by heating the preliminary front-substrate assembly FTA at 450 degrees centigrade in air for ten minutes, for example, thereby fixing one end face of each of the spacers 12 to the front substrate 2 via the adhesive members 13.

On the other hand, initially formed on the rear substrate 1 are a plurality of video signal lines 8 which extend in a first direction, for example, the Y direction, and are arranged in a second direction intersecting the first direction, for example, the X direction; a plurality of scanning signal lines 9 which extend in the second direction, for example, the X direction, and are arranged in the first direction intersecting the second direction, for example, the Y direction; and a plurality of electron sources 10, and then a preliminary rear-substrate assembly BTA is formed by coating the adhesive members 13 and the sealing member 5 each including appropriate binder on the rear substrate 1 in the form of desired patterns, respectively. Here the adhesive members 13 having characteristics different from each other may be utilized for the rear substrate 1 and the front substrate 2, respectively. A rear-substrate assembly BPA is formed by subjecting a preliminary front-substrate assembly BTA to a preliminary firing at a temperature high enough to drive off the binder, about 150 degrees centigrade.

On the other hand, the support member 3 are coated on both its end faces with the sealing members 5, and then a support member assembly SPA is formed by subjecting the support member 3 to a preliminary firing at a temperature high enough to drive off the binder, about 150 degrees centigrade.

Next, a preliminary panel assembly PSA is formed by stacking the front-substrate assembly FPA having the spacers 12 each fixed at its one end face to the front substrate 2, the rear-substrate assembly BPA and the support assembly SPA in the Z direction (see FIG. 1(a)), and then the rear and front substrates 1, 2 and the support member 3 are hermetically sealed together via the sealing member 5 by heating at 430 degrees centigrade for ten minutes, for example, while pressing the front-substrate assembly FPA, the rear-substrate assembly BPA and the support assembly SPA against each other in the Z direction. Here, simultaneously with the above hermetic sealing, the other end face of each of the spacers 12 is fixed to the rear substrate 2 via the adhesive members 13.

Next, the space enclosed by the rear and front substrates 1, 2 and the support member 3 and forming a display area is evacuated via the exhaust tubulation 4 while baked. The baking and evacuation is performed by placing the preliminary panel assembly PSA in an evacuated furnace, for example, and baking it at temperatures the maximum of which is lower than a softening temperature of the adhesive members 13, at 380 degrees centigrade, for example, for several hours. If the image display device is of the type not provided with an exhaust tubulation, the baking and evacuation step may be performed simultaneously with the above-explained hermetic sealing.

In the case of the configuration provided with the exhaust tubulation, the exhaust tubulation is tipped off after completion of the exhaustion of gases, and thereafter the image display device is completed after being subjected to required treatments such as aging and others.

The following will explain an example of a method of fabricating the phosphor screen for the above-explained image display device in detail. Formed on a glass plate for the front substrate are the BM film 16, the three-color phosphor layers 15, an organic planarizing film (filming film), and the metal back film 17 in this order. The BM film 16, the three-color phosphor layers 15 and the organic planarazing film are fabricated by using well-known conventional methods. Although the example will be explained by using a glass substrate of 17 inches in a diagonal screen dimension, the following equally applies to glass substrates of other dimensions.

Initially, a two-layer film was fabricated on the glass substrate by sputtering chromium oxide and metal chromium to thicknesses of 50 nm and 200 nm, respectively, on the glass substrate. Thereafter, the two-layer film was patterned by using a photolithographic method to provide the BM film 16 provided with openings 161.

Next, the pattern of green phosphor layers 15G were formed by using a screen printing method using a green phosphor paste comprised of green phosphors of 6 microns in average particle diameter, a cellulose-system resin and 2-(2-n-Butoxyethoxy) ethyl acetate, and then the patterns of blue phosphor layers 15B and red phosphor layers 15R were formed similarly and respectively. Thereafter, an ink comprised of acrylic/cellulose resin and high-boiling-point solvent was printed on the phosphor layers in the form of a pattern, and then is dried to form the organic planarizing film (filming film). The surface roughness Rz of the thus obtained filming film was 10 microns.

The metal back film 17 was formed by using a dc magnetron sputtering method using an aluminum target and an argon discharge gas. The condition for the film thickness of 100 nm was established by depositing on a flat glass substrate at the deposition speed of 0.5 nm/sec for 200 seconds. Under this condition, when formation of a sputtered film was performed on the above-obtained filming film of the surface roughness Rz of 10 microns, formed is the metal back film 17 having an aluminum thickness of 70 nm, a mass per unit area of aluminum of 25 μg/cm², and a film density of 2.5 g/cm³. The thickness was measured by using a field emission type scanning electron microscope (Type S-5000 manufactured by Hitachi, Ltd.). The mass per unit area was measured by using a method of inductively coupled plasma spectrometry on the metal back film 17 dissolved into hydrochloric acid after being peeled from the substrate. The film density was obtained by computing based upon the above-explained film thickness and the above-explained mass per unit area. The reason why the measured aluminum thickness is smaller than the aluminum thickness for which the above condition is established using the flat substrate is that the area of the surface was increased due to presence of the surface roughness of the metal back film 17.

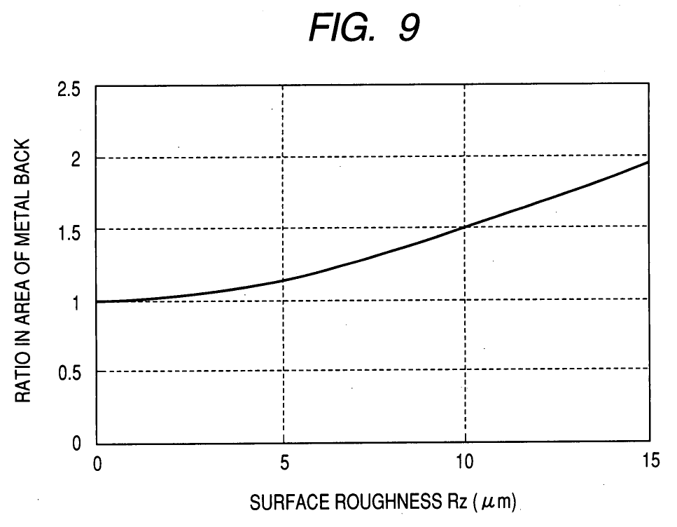

FIG. 9 is a graph showing a relationship between a ratio in surfaces and the surface roughness Rz of the phosphor layers after completion of the filming step. When the conditions for deposition is established using a flat substrate, the roughness of the underlying layer needs to be taken into consideration. The total luminous reflectance of the aluminum film was measured by using a spectrophotometer, Type U-3300 manufactured by Hitachi, Ltd., an integrating sphere having an inner wall made of barium sulfate and a reference made of alumina, and the aluminum film exhibited a highly total luminous reflectance of 90%.

Organic materials in the phosphor layers and the filming films were burned off by panel baking, and a layer of oxide of 5 nm in thickness was formed on the surface of the aluminum film. This oxide layer made thicker by the sealing and evacuating steps. Analyzing of the aluminum film disassembled from the evacuated device by using secondary ion mass spectrometry showed that the thickness of the oxide layer on the surface increased to 10 nm, and the aluminum film exhibited the total luminous reflectance of 85% including regular and diffuse reflection.

An image display device was fabricated which employs the phosphor screen of the above configuration and electron sources of the MIM (Metal-Insulator-Metal) type, and when it was operated at an anode voltage of 7 kV, it exhibited luminance of 140% compared with that of an image display device not employing a metal back film, and this improvement in brightness was pronounced.

### Embodiment 4

The structure of the phosphor screen as far as the filming film was fabricated as in the case of Embodiment 3. Sputtering at a deposition speed of 1.5 nm/sec for 65 seconds formed the metal back film 17 having the thickness of 70 nm, the mass of aluminum per unit area of 2.0 μg/cm², and a film density of 2.0 g/cm³. In this way the film thickness is controlled by adjusting the deposition speed and the deposition time. Reducing of the deposition speed makes the aluminum film denser, and increasing of the deposition speed makes the aluminum film less dense. Further, the film density can be controlled by adjusting the pressure of discharge gas or a temperature of the substrate.

The dense aluminum film exhibits a high light reflectance, but it tends to swell after panel baking. On the other hand, the less dense aluminum film does not swell easily. The above obtained aluminum film exhibited the surface roughness Rz of 10 μm and the total luminous reflectance of 80%.

An image display device was fabricated which employs the phosphor screen of the above configuration and electron sources of the MIM (Metal-Insulator-Metal) type, and when it was operated at an anode voltage of 7 kV, it exhibited luminance of 125% compared with that of an image display device not employing a metal back film, and this improvement in brightness was pronounced. Further, the total luminous reflectance measured after the panel baking was 75%.

### Embodiment 5

The structure of the phosphor screen as far as the filming film was fabricated as in the case of Embodiment 3, but if the speed of drying the filming film is increased, the filming film is made flatter. If a film such as a collodion film is formed, a flatter film can be obtained. However, if the surface roughness Rz is made equal to or smaller than 3 μm, the number of attachments of the metal back film to the phosphor layers becomes smaller, the adhesion of the metal back film to the phosphor layers decreases. Consequently, when a high voltage is applied to the panel, the metal back film peels off from the phosphor layers easily. Therefore the surface roughness Rz of the filming film, that is, the surface roughness Rz of the metal back film needs to be equal to or greater than 3 μm. The upper limit of the surface roughness Rz is limited by the light reflectance of the metal back film. If the surface roughness Rz exceeds 15 μm, the light reflectance is reduced exceedingly, and it is practical to select the surface roughness Rz to be 15 μm or smaller.

### Embodiment 6

After the BM pattern was formed as in the case of Embodiment 3, formation of the phosphor films was performed by using a slurry method which has been giving satisfactory results in manufacture of cathode ray tubes. To be more specific, green phosphor slurry containing polyvinyl alcohol and sodium bichromate was coated on the BM substrate, then it was dried, then was exposed, and thereafter was developed to form a green phosphor film pattern. Thereafter, the patterns of the blue and red phosphor films were formed similarly. Next, the emulsion comprised chiefly of acrylic resin was coated and dried to form a filming film.

The metal back film was formed by evaporation of aluminum. Obtained by evaporating at a deposition speed of 1.5 nm/sec for 100 seconds is an aluminum film having a thickness of 70 nm, a mass of aluminum per unit area of 23 μg/cm², a film density of 2.3 g/cm³. This aluminum film formed on the phosphor films exhibited the surface roughness Rz of 9 μm and a high reflecting characteristic of the total luminous reflectance of 86%.

Although the surface roughness Rz of this Embodiment is smaller than that of Embodiment 3, the light reflectance is low in this Embodiment. This is because a distribution density of pinholes in a range of from 1 μm to 2 μm in diameter is higher in the aluminum film fabricated by using the emulsion filming method. The total luminous reflectance of the aluminous film after being subjected to panel baking was 82%. As shown in FIG. 6, swelling of the aluminum film did not occur because organic materials contained in the phosphor films burn easily due to presence of fine pinholes 171, and combustion gases were emitted through the fine pinholes 171.

An image display device was fabricated which employs the phosphor screen of the above configuration and electron sources of the MIM (Metal-Insulator-Metal) type, and when it was operated at an anode voltage of 7 kV, it exhibited luminance of 135% compared with that of an image display device not employing a metal back film, and this improvement in brightness was pronounced.

### Embodiment 7

The structure of the phosphor screen as far as the organic planarizing film was fabricated as in the case of Embodiment 4. Then an aluminum film having the thickness of 100 nm and a lower film density of 1.6 g/cm³ was obtained by evaporating aluminum at a deposition speed of 0.5 nm/sec for 200 seconds with a stainless steel mesh of 25% in aperture ratio interposed between a evaporation source and the substrate. The film density can be controlled by adjusting the aperture ratio of the stainless steel mesh. The above-obtained aluminum film exhibited the surface roughness Rz of 9 μm and the total luminous reflectance of 78%. Further, the total luminous reflectance measured after the panel baking was 73%.

Further, the spectral reflectances of the aluminum film at 400 nm and 700 nm were 65% and 74%, respectively, and the difference between them was 9%. Since the reflectance in the region of emission color of the blue phosphor was lowered, an image display device employing the phosphor screen of the above configuration and the electron sources of the MIM type exhibited luminance of 120% compared with an image display device without the metal back film when the image display devices were operated at an anode voltage of 7 kV. If the film density is made lower, the light reflectance is further lowered in the short wavelength region, there is a fear that the metal back film cannot provide an improvement in brightness of the metal back film.

### Embodiment 8

The front substrate was fabricated as in the case of Embodiment 3, and was subjected to the steps up to the evacuation step shown in FIG. 8, and thereafter a barium-system getter was flashed to maintain the interior of the panel at a high degree of vacuum. Here, by flashing the getter such that a small amount of barium is deposited on the surface of the metal back film, the entire area of the panel is made capable of adsorbing gases. A small amount of barium deposits of 2 μg/cm² or less on the average was able to maintain the luminance of the panel after operation of twenty thousand hours at least 10% higher than that of a panel not provided with the barium deposits.

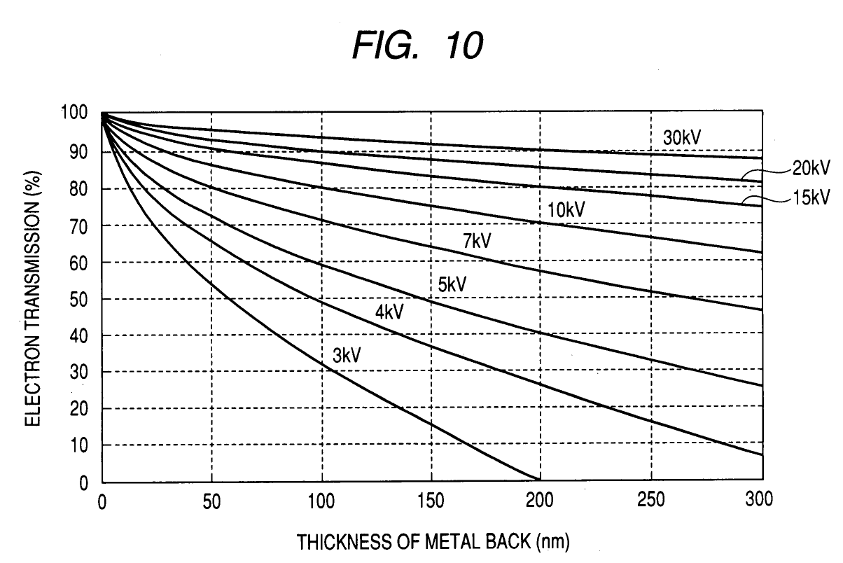

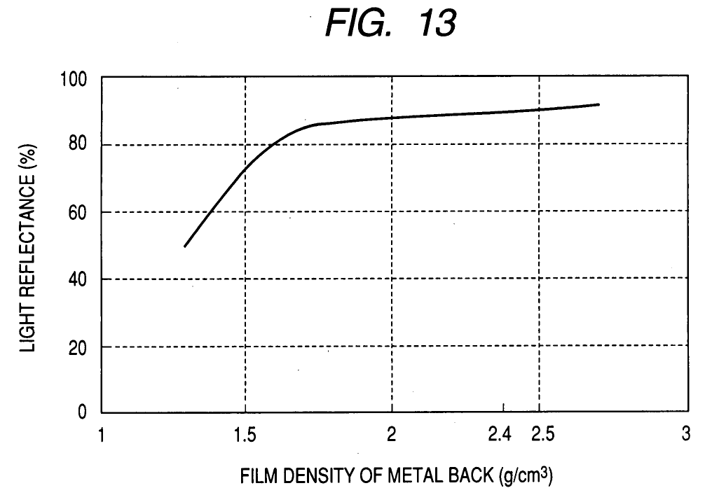

FIGS. 10 to 13 are graphs for explaining the image display devices in accordance with the present invention employing the aluminum films of the film density of 2.4 g/cm³ which is 90% of the density of bulk-state aluminum, 2.7 g/cm³, fabricated by using a method of the present invention including those of the previous embodiments. FIGS. 10, 11 and 12 are graphs showing relationships of electron transmission, light reflectance and relative luminance, respectively, versus the film thickness, and FIG. 13 is a graph showing a relationship between the film density and the light reflectance.

First, FIG. 10 shows the relationship between electron transmission and the thickness of the metal back film, measured using the anode voltage as a parameter, where a usual anode-voltage range of from 3 kV to 30 kV used for this kind of image display devices is divided into eight.

FIG. 10 shows that in the case of the anode voltage of 3 kV, if the aluminum film thickness exceeds 200 nm, transmission of electron does not occur, and therefore the image display device does not function. The anode voltage of 3 kV is usually utilized for this kind of FPD, and considering the transmission of electrons the film thickness of 200 nm or smaller is desirable. A combination of the anode voltage of 3 kV and the film thickness of 50 nm can ensure the electron transmission of about 50%.

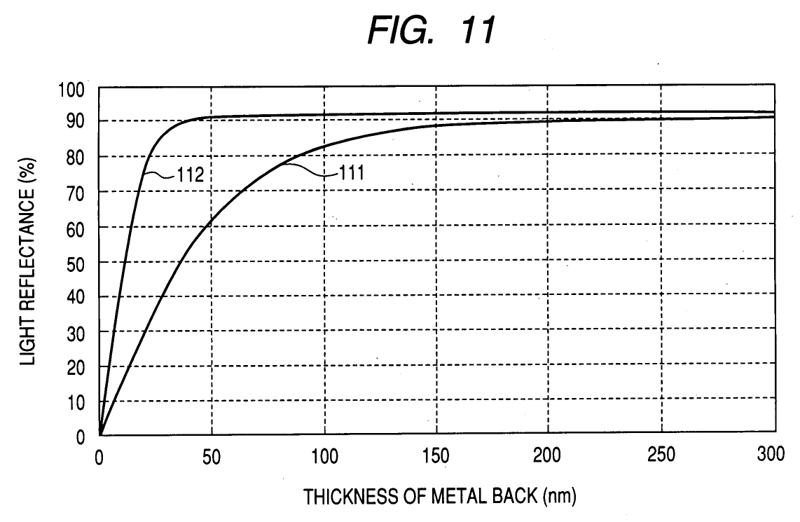

Secondly, in FIG. 11, curve 111 represents the light reflectance of the metal back film 17 formed on the phosphor layer 15 as illustrated in FIG. 6, and curve 112 represents the light reflectance of a metal back film formed directly on a glass substrate without applying the phosphor layer 15 on the glass substrate.

Curve 112 in FIG. 11 shows that in the case of the configuration having no phosphor layers, the thickness of the metal back film of about 20 nm produces the light reflectance exceeding the minimum value of 60% required for this kind of image display devices.

On the other hand, in the case of the configuration provided with the phosphor layer like the image display device in accordance with the present invention, the thickness of the metal back film of about 50 nm or more produces the light reflectance exceeding 60%, and a cause for this is thought to be influences of the phosphor layers. Therefore the thickness of 50 nm is desirable.

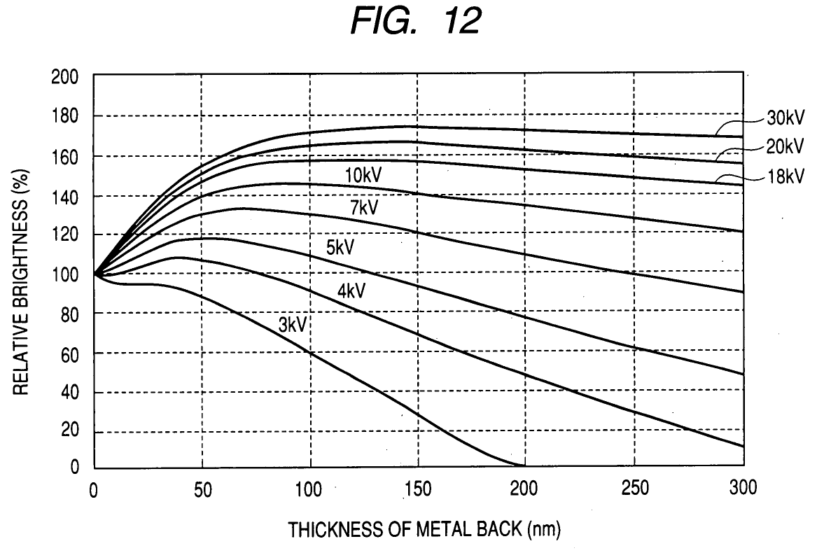

Thirdly, FIG. 12 shows electron-blocking characteristics of the metal back film, that is, degradation in display brightness versus the thickness of the metal back film, compared with the configuration having no metal back film, in other words, degradation in display brightness versus blocking of electrons. FIG. 12 shows that it is necessary for improvement in brightness to increase an anode voltage, to reduce the thickness of the metal back film. In the case of image display devices characterized by low-voltage driving using voltages in a range of from 5 kV to 15 kV, an improvement in brightness in connection with the metal back film is obtained more effectively by selecting its thickness to be in a range of 50 nm to 200 nm.

Fourthly, FIG. 13 shows a relationship between light reflectance and the film density of the metal back film made of aluminum fabricated by using the above-described method of fabricating the phosphor screen. In the relationship between the film density and light reflectance, the light reflectance begins to fall at the film density of 1.6 g/cm³, and falls rapidly at the film density smaller than 1.6 g/cm³.

On the other hand, when the film density exceeds 2.6 g/cm³, the film becomes dense without occurrence of pinholes, combustion gases produced by heat treatment during the step for fabricating the phosphor screen cannot escape, and the aluminum film swells. Consequently, resultant peeling or breaking of the aluminum film causes defects in the phosphor screen. In view of the above, the practical range of the film density is from 1.6 g/cm³ to 2.6 g/cm³, and the film density is preferably in a range of from 1.8 g/cm³ to 2.4 g/cm³ since variations in light reflectance are small in this range.

The above embodiments have been explained as the image display devices employing electron sources of the MIM type, the present invention is not limited to this configuration, but it is needless to say that various kinds of electron sources can be utilized for the present invention.

What is claimed is:

1. An image display device comprising:
a front substrate having phosphor layers and a light reflective film succeeding said phosphor layers and comprised chiefly of aluminum on an inner surface thereof;
a rear substrate having a plurality of electron sources on an inner surface thereof, and disposed to oppose said front substrate with a specified spacing between said front and rear substrates; and
a support member which is sandwiched between said front and rear substrates, surrounds a display area formed between said front and rear substrates, and maintains said specified spacing;
two end faces of said support member being hermetically sealed to said front substrate and said rear substrate, respectively, via sealing members,
wherein a thickness of said light reflective film is in a range of from 50 nm to 200 nm, and an average film density of said light reflective film is in a range of from 1.6 g/cm³ to 2.6 g/cm³.

2. An image display device according to claim 1, wherein said rear substrate is provided with:
a plurality of scanning signal lines extending in one direction and arranged in another direction intersecting said one direction, said plurality of scanning signal lines being adapted to be supplied with a scanning signal successively in said another direction;
a plurality of video signal lines extending in said another direction and arranged in said one direction to intersect said plurality of scanning signal lines;
a plurality of electron sources each disposed in a vicinity of a corresponding one of intersections of said plurality of scanning signal lines and said plurality of video signal lines; and
a plurality of connector electrodes which couples each of said plurality of electron sources to a corresponding one of said plurality of scanning signal lines.

3. An image display device according to claim 1, wherein said average film density of said light reflective film is in a range of from 1.8 g/cm³ to 2.4 g/cm³.

4. An image display device according to claim 1, wherein said light reflective film is comprised chiefly of aluminum, and contains at least one of neodymium, manganese and silicon.

5. An image display device according to claim 1, wherein said light reflective film is provided with a passive-state film on an outer surface thereof.

6. An image display device according to claim 1, wherein a mass per unit area of said aluminum in said light reflective film is in a range of from 10 μg/cm² to 50 μg/cm² in said display area.

7. An image display device according to claim 1, wherein said light reflective film is provided with pinholes therein.

8. An image display device according to claim 1, wherein said light reflective film is provided with pinholes therein, and a diameter of said pinholes is equal to or smaller than 5 μm.

9. An image display device according to claim 1, wherein said light reflective film is provided with pinholes therein, and a diameter of said pinholes is in a range of from 1 μm to 2 μm.

10. An image display device according to claim 1, wherein a total luminous reflectance of said light reflective film is equal to or greater than 60%.

11. An image display device according to claim 1, wherein a difference between a maximum and a minimum of spectral reflectance of said light reflective film is equal to or smaller than 10% in a visible region of from 400 nm to 700 nm in wavelength.

12. An image display device according to claim 1, wherein said light reflective film is provided with roughness equal to greater than a thickness of said light reflective film.

13. An image display device according to claim 1, wherein Rz (ten points average height, peak to valley average) of said light reflective film is in a range of from 3 μm to 15 μm.

14. An image display device according to claim 5, wherein said passive-state film of said light reflective film is provided with at least one of barium, magnesium, iron, nickel and titanium on a surface of said passive-state film.

15. An image display device comprising:
a front substrate having a black matrix film having a plurality of openings therein and disposed on an inner surface of said front substrate, phosphor layers filling and extending outside of said plurality of openings, and a light reflective film covering said phosphor layers and said black matrix film and comprised chiefly of aluminum;
a rear substrate having a plurality of electron sources on an inner surface thereof, and disposed to oppose said front substrate with a specified spacing between said front and rear substrates;
a plurality of spacing-maintaining members which are sandwiched between said front and rear substrates in a display area formed between said front and rear substrates; and
a support member which is sandwiched between said front and rear substrates, surrounds said display area, and maintains said specified spacing;
two end faces of said support member being hermetically sealed to said front substrate and said rear substrate, respectively, via sealing members,
wherein a thickness of said light reflective film is in a range of from 50 nm to 200 nm, an average film density of said light reflective film is in a range of from 1.6 g/cm³ to 2.6 g/cm³, and said light reflective film is provided with a passive-state film on an outer surface thereof.

16. An image display device according to claim 1, wherein said light reflective film is adapted to be supplied with an anode voltage in a range of from 5 kV to 15 kV.
